(19) United States
(12) Patent Application Publication
(10) Pub. No.: US 2026/0204617 A1
(43) Pub. Date: Jul. 16, 2026

(54) METHOD OF MANUFACTURING POWER STORAGE DEVICE AND POWER STORAGE DEVICE

(71) Applicant: TOYOTA JIDOSHA KABUSHIKI KAISHA, Toyota-shi (JP)

(72) Inventors: Mitsuru TATEISHI, Toyota-shi (JP); Hajime HASEGAWA, Aichi-ken (JP); Takuya SHIMOTSUBO, Nisshin-shi (JP)

(73) Assignee: TOYOTA JIDOSHA KABUSHIKI KAISHA, Toyota-shi (JP)

(21) Appl. No.: 19/393,981

(22) Filed: Nov. 19, 2025

(30) Foreign Application Priority Data
Jan. 15, 2025 (JP) 2025-005278

(51) Int. Cl. H01M 10/04; H01M 50/264

(52) U.S. Cl. CPC H01M 10/0481; H01M 50/264

(57) ABSTRACT

A method of manufacturing a power storage device includes a step of injecting an electrolytic solution into each power storage module of a stacked body in which a plurality of power storage modules are stacked in a stacking direction, a first restraining step of restraining the stacked body in the stacking direction by a first restraining force after the injecting step, a step of charging the plurality of power storage modules in a state of being restrained by a first restraining force, a second restraining step of restraining the stacked body in the stacking direction by a second restraining force higher than the first restraining force after the charging step, and a third restraining step of restraining the stacked body in the stacking direction by a first restraining force after the second restraining step.

### CROSS-REFERENCE TO RELATED APPLICATION

This application claims priority to Japanese Patent Application No. 2025-005278 filed on January 15, 2025. The disclosure of the above-identified application, including the specification, drawings, and claims, is incorporated by reference herein in its entirety.

### BACKGROUND

### 1. Technical Field

The present disclosure relates to a method of manufacturing a power storage device and a power storage device.

### 2. Description of Related Art

As a conventional method of manufacturing a power storage device, Japanese Unexamined Patent Application Publication No. 2014-93270 (JP 2014-93270 A) discloses a method of compressing a plurality of single cells with a compression force that is slightly greater than a maximum restraining force with which the single cells are finally restrained, and then restraining the cells with the maximum restraining force.

When the single cells are compressed with a compression force that is considerably greater than the maximum restraining force, a conductive foreign matter that is present in an electrode body may penetrate a separator, and a positive electrode and a negative electrode may be electrically connected to each other by the foreign matter, resulting in a short circuit. However, when the compression force is slightly greater than the maximum restraining force, it is possible to suppress a small conductive foreign matter that is present in the electrode body penetrating the separator.

### SUMMARY

In the method of manufacturing a power storage device described in JP 2014-93270 A, when a considerably large conductive foreign matter is present in the electrode body, there is a possibility that the foreign matter penetrates the separator in the first compression step and the positive electrode and the negative electrode are short-circuited via the foreign matter.

The present disclosure provides a method of manufacturing a power storage device capable of suppressing a short circuit due to a conductive foreign matter, and a power storage device.

An aspect of the present disclosure provides a method of manufacturing a power storage device, including:

injecting an electrolyte into each of a plurality of power storage modules of a stacked body in which the power storage modules are stacked in a stacking direction;

after the injecting, restraining the stacked body in the stacking direction with a first restraining force as a first restraining step;

charging the power storage modules in a state of being restrained with the first restraining force;

after the charging, restraining the stacked body in the stacking direction with a second restraining force that is greater than the first restraining force as a second restraining step; and

after the second restraining step, restraining the stacked body in the stacking direction with the first restraining force as a third restraining step.

In the method of manufacturing a power storage device according to the aspect of the present disclosure,

the second restraining force may be equal to or greater than eight times the first restraining force.

In the method of manufacturing a power storage device according to the aspect of the present disclosure,

each of the power storage modules may include a positive electrode and a negative electrode arranged in the stacking direction, and a separator disposed between the positive electrode and the negative electrode.

A precipitated foreign matter dissolved at the positive electrode and precipitated from the negative electrode may be present in any of the power storage modules.

In this case, the precipitated foreign matter may be cut in the stacking direction by a difference in restraining force between the second restraining step and the third restraining step.

In the method of manufacturing a power storage device according to the aspect of the present disclosure,

the precipitated foreign matter may be SUS-based metal.

An aspect of the present disclosure provides a power storage device including:

a stacked body including a plurality of power storage modules;

a restraining tool that restrains the stacked body;

an adjustment device that adjusts a restraining force by the restraining tool; and

a control device that controls operation of the adjustment device.

The control device controls the operation of the adjustment device so as to return the restraining force to a first restraining force for a normal state after being brought to a second restraining force that is greater than the first restraining force, as control for suppressing a short-circuit path of the power storage modules.

According to the present disclosure, it is possible to provide a method of manufacturing a power storage device capable of suppressing a short circuit due to a conductive foreign matter, and a power storage device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flowchart illustrating a manufacturing process of a power storage device according to a first embodiment;

FIG. 2 is a diagram illustrating a first restraining step in a manufacturing process of the power storage device according to the first embodiment;

FIG. 3 is a schematic cross-sectional view illustrating a power storage module included in the power storage device according to the first embodiment;

FIG. 4 is a partially enlarged cross-sectional view schematically showing a state of an electrode layer restrained by a first restraining force in a manufacturing process of the power storage device according to Embodiment 1;

FIG. 5 is a partially enlarged cross-sectional view schematically showing a state of an electrode layer restrained by a second restraining force in a manufacturing process of the power storage device according to Embodiment 1;

FIG. 6 is a partially enlarged cross-sectional view schematically showing a state of the electrode layer in a state of returning from the second restraining force to the first restraining force in the manufacturing process of the power storage device according to Embodiment 1;

FIG. 7 is a diagram illustrating a change in the short-circuit resistance of the power storage device according to the first embodiment when the power storage device is restrained by the respective restraining forces; and

FIG. 8 is a schematic diagram illustrating a power storage device according to a second embodiment.

### DETAILED DESCRIPTION OF EMBODIMENTS

Hereinafter, embodiments of the present disclosure will be described in detail with reference to the drawings. In the following embodiments, the same or common parts are denoted by the same reference numerals in the drawings, and the description thereof will not be repeated.

### First Embodiment

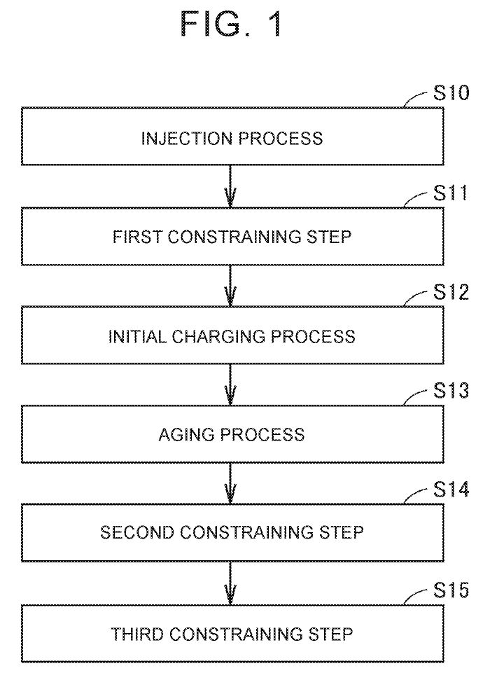

FIG. 1 is a flowchart illustrating a manufacturing process of a power storage device according to a first embodiment. A method of manufacturing the power storage device according to the first embodiment will be described with reference to FIG. 1.

As illustrated in FIG. 1, the power storage device according to the first embodiment includes a liquid injection step (S10), a first restraining step (S11), an initial charging step (S12), an aging step (S13), a second restraining step (S14), and a third restraining step (S15).

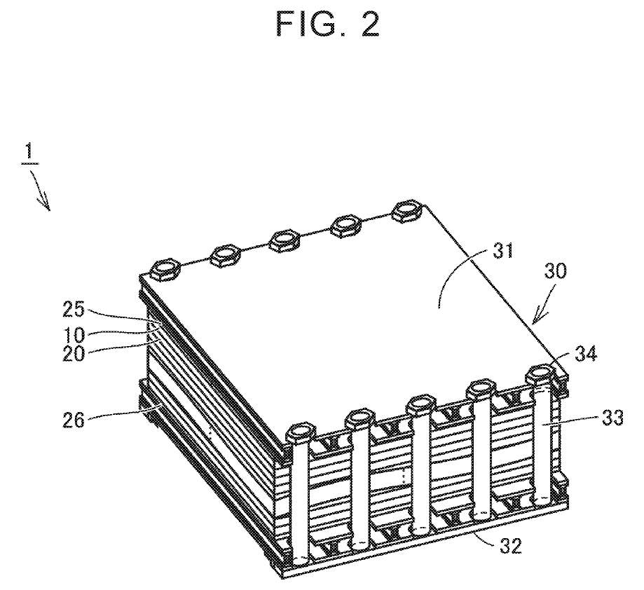

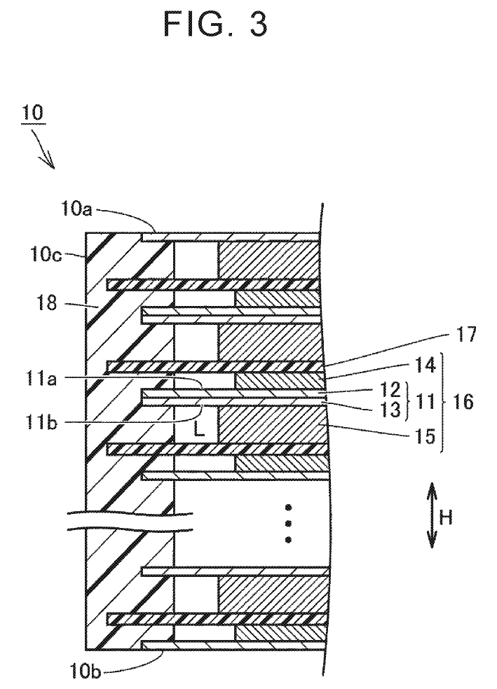

In manufacturing the power storage device, first, in the liquid injection step (S10), the electrolytic solution L (see FIG. 3) is injected into the respective power storage modules 10 of the stacked body 1 (see FIG. 2) in which the plurality of power storage modules 10 (see FIG. 2) are stacked in the stacking direction.

The stacked body 1 is configured by stacking a plurality of power storage modules 10, a plurality of spacers 20 (see FIG. 2), and elastic sheets 25 and 26 (see FIG. 2).

The plurality of power storage modules 10 and the plurality of spacers 20 are alternately stacked between the elastic sheets 25 and 26. The elastic sheets 25 and 26 are formed of, for example, a foamed resin sheet such as urethane foam. The spacer 20 has conductivity. The spacer 20 includes, for example, a pair of elastic bodies (not shown) and a conductive plate (not shown) disposed between the pair of elastic bodies. The conductive plate supports a pair of elastic bodies. A conductive sheet is wound around the pair of elastic bodies. Note that the elastic body is not limited to a pair, and may be a single elastic body.

The respective power storage modules 10 are provided with liquid injection holes, and in the liquid injection step (S10), the electrolytic solution L is injected into the power storage modules 10 through the liquid injection holes.

FIG. 2 is a diagram illustrating a first restraining step in a manufacturing step of the power storage device according to the first embodiment. Subsequently, in the first restraining step (S11), the stacked body 1 is restrained in the stacking direction by the first restraining force.

Specifically, the stacked body 1 is restrained by using the restraining member 30. The restraining member 30 includes a first restraining plate 31, a second restraining plate 32, a plurality of rods 33, and a plurality of fastening parts 34 such as nuts. The first restraining plate 31 and the second restraining plate 32 are made of a metallic member such as SUS. The first restraining plate 31 and the second restraining plate 32 are provided with insertion portions through which the plurality of rods 33 is inserted.

In a state in which the stacked body 1 is sandwiched between the first restraining plate 31 and the second restraining plate 32, the first restraining plate 31 and the second restraining plate 32 are fastened by the first restraining force using the plurality of rods 33 and the plurality of fastening parts 34, whereby the stacked body 1 can be restrained by the first restraining force. The first binding force is, for example, a 20 KPa.

Note that the configuration of the restraining member 30 is not limited to the above, and can be appropriately changed as long as the stacked body 1 can be restrained.

In the liquid injection step (S10) described above, the stacked body 1 may be restrained by the restraining member 30 at a pressure that does not decompose.

FIG. 3 is a schematic cross-sectional view illustrating a power storage module included in the power storage device according to the first embodiment. Details of the power storage module 10 will be described with reference to FIG. 3.

As shown in FIG. 3, the power storage module 10 according to the first embodiment is constituted by a so-called bipolar battery. The power storage module 10 has a substantially rectangular parallelepiped shape. The power storage module 10 includes a first surface portion 10a, a second surface portion 10b, and a peripheral surface portion 10c. The power storage module 10 includes a plurality of electrodes 16, a plurality of separators 17, and a sealing portion 18.

The electrode 16 is a bipolar electrode. The electrode 16 includes a current collector plate 11 and electrode layers 14 and 15. The current collector plate 11 is provided in a plate shape, and has a first main surface 11a and a second main surface 11b arranged in a direction parallel to the stacking direction. The current collector plate 11 includes a first plate portion 12 and a second plate portion 13 stacked in a direction parallel to the stacking direction. The first main surface 11a described above is constituted by the main surface of the first plate portion 12. The second main surface 11b is constituted by the main surface of the second plate portion 13.

The electrode layers 14 and 15 are formed inside the periphery of the current collector plate 11. The electrode layers 14 are provided on the first main surface 11a of the current collector plate 11 located on one side in a direction parallel to the stacking direction. The electrode layers 15 are provided on the second main surface 11b of the current collector plate 11 located on the other side in the direction parallel to the stacking direction.

The electrode layer 14 is a positive electrode and includes a positive electrode active material layer. As the positive electrode active material, a known material can be employed. The electrode layer 14 may contain a conductive material and a binder in addition to the positive electrode active material. The electrode layer 15 is a negative electrode and includes a negative electrode active material. As the negative electrode active material, a known material can be employed.

The separator 17 is disposed between the electrode layers 14 and 15 formed on the electrodes 16 adjacent to each other as described above. Specifically, it is disposed between the electrode layer 15 of the electrode 16 located on one side in the up-down direction and the electrode layer 14 of the electrode 16 located on the other side in the up-down direction. The separator 17 is disposed between the electrode layer 14 as the positive electrode and the electrode layer 15 as the negative electrode.

The separator 17 may be formed in a sheet shape, for example. Examples of the sheet-shaped separators 17 include porous films made of polyolefin-based resins such as polyethylene (PE) and polypropylene (PP), woven fabrics or nonwoven fabrics made of polypropylene, polyethylene terephthalate (PET), methylcellulose, and the like. The separator 17 may be reinforced with a vinylidene fluoride resin compound.

The sealing portion 18 seals the peripheral edges of the plurality of electrodes 16 so that a space is formed between the electrodes 16 adjacent to each other in the up-down direction. The sealing portion 18 seals the space. The outer peripheral surface of the sealing portion 18 constitutes a peripheral surface portion 10c of the power storage module 10.

The peripheral edges of the plurality of electrodes 16 are embedded in the sealing portion 18, and thereby the sealing portion 18 holds the plurality of electrodes 16.

The sealing portion 18 is made of, for example, an insulating resin. The sealing portion 18 may be composed of, for example, polypropylene (PP), polyphenylene sulfide (PPS), or modified polyphenylene ether (modified PPE).

The electrolytic solution L is accommodated in the above-described space formed between the electrodes 16 adjacent to each other. The electrolytic solution L is impregnated into the electrode layers 14 and 15 and the separator 17.

As described above, each power storage module 10 includes the electrode layer 14 and the electrode layer 15 arranged in a direction parallel to the stacking direction, and the separator 17 arranged between the electrode layer 14 and the electrode layer 15. In each power storage module 10, a unit battery is constituted by a first plate portion 12, an electrode layer 14, a separator 17, an electrode layer 15, and a second plate portion 13 stacked in a direction parallel to the stacking direction.

Referring back to FIG. 1, in the initial charging step (S12), the plurality of power storage modules 10 are initially charged. Specifically, for example, charging is performed for each of the above-described unit batteries included in the plurality of power storage modules 10 using a charging device (not shown). Further, the initial charging is performed in a state in which the stacked body 1 is restrained by the first restraining force.

Subsequently, in the aging step (S13), the stacked body 1 is left to stand for a predetermined period of time at a predetermined temperature while the stacked body 1 is restrained by the first restraining force. The aging step (S13) may be omitted.

Subsequently, in the second restraining step (S14), the stacked body 1 is restrained in the stacking direction with a second restraining force higher than the first restraining force. The second binding force is greater than or equal to eight times the first binding force. Specifically, for example, the second binding force may be 160 KPa. The second binding force may be equal to or greater than 160 KPa. The second binding force may be equal to or less than 1 MPa. In the second restraining step (S14), a restraining member 30 similar to the first restraining step (S11) is used. Accordingly, the restraining force can be continuously changed without replacing the restraining member 30 with another restraining member. The binding at the second binding force is performed for a predetermined time.

Subsequently, in the third step (S15), the stacked body 1 is restrained in the stacking direction by the first restraining force. The first binding force is the same as the binding force in the first restraining step (S11). In the third restraining step (S15), a restraining member 30 similar to the first restraining step (S11) and the second restraining step (S14) is used. Thus, the restraining force can be continuously changed without replacing the restraining member 30 with another restraining member. The binding at the first binding force is performed for a predetermined time.

Subsequently, the restraining force is released, each power storage module is taken out from the stacked body 1, the power storage module 10 and the spacer and/or the cooler are arranged in a predetermined direction, and the power storage device is assembled by restraining the power storage module in a predetermined restraining force. Thus, the power storage device is manufactured.

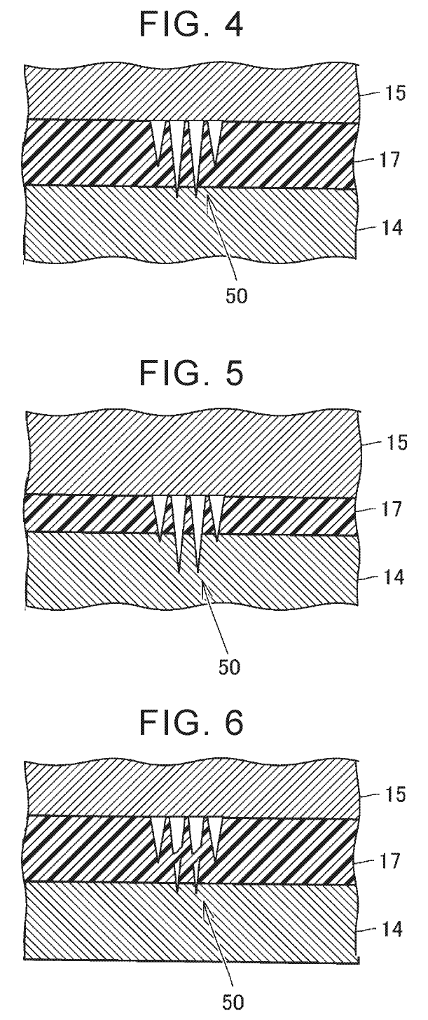

FIG. 4 is a partially enlarged cross-sectional view schematically showing a state of the electrode layer constrained by the first restraining force in the manufacturing process of the power storage device according to Embodiment 1. FIG. 5 is a partially enlarged cross-sectional view schematically showing a state of an electrode layer restrained by a second restraining force in a manufacturing process of the power storage device according to Embodiment 1. FIG. 6 is a partially enlarged cross-sectional view schematically showing a state of the electrode layer in a state of returning from the second restraining force to the first restraining force in the manufacturing process of the power storage device according to Embodiment 1.

Referring to FIGS. 4 to 6, the change of the foreign matter from the first restraining step to the third restraining step will be described.

As shown in FIG. 4, in a state in which the stacked body 1 is restrained by the first restraining force, the electrode layer 14 and the electrode layer 15 are pressed in the approaching direction. In any of the plurality of power storage modules 10, there may be conductive precipitated foreign matter 50 dissolved in the electrode layer 14 and deposited from the electrode layer 15.

In such a case, when the electrode layer 14 and the electrode layer 15 are pressed in the approaching direction, the precipitated foreign matter 50 may penetrate the separator 17, and the electrode layer 14 and the electrode layer 15 may be short-circuited.

The precipitated foreign matter 50 is precipitated along the pores provided in the separator 17. The precipitated foreign matter 50 is, for example, a SUS metal-based material. More particularly, the precipitated foreign matter 50 is SUS 304.

The precipitated foreign matter 50 includes, for example, Fe, Cr, and Ni. The precipitated foreign matter 50 is not in an alloyed state, but in a state in which Fe, Cr, and Ni are precipitated.

As shown in FIG. 5, in the second restraining step (S14) described above, when the stacked body 1 is restrained by the second restraining force, the second restraining force is higher than the first restraining force, so that the electrode layer 14 and the electrode layer 15 are compressed further toward each other. The precipitated foreign matter 50 is also compressed. As a result, the electrode layer 14 and the electrode layer 15 are more likely to be short-circuited by the precipitated foreign matter 50, and the short-circuit resistance is lowered.

As shown in FIG. 6, in the third restraining step (S15) described above, by switching from the second restraining force to the first restraining force lower than the second restraining force, the precipitated foreign matter 50 is broken by the reaction. That is, the precipitated foreign matter 50 is cut in the stacking direction by the difference in the restraining force from the second restraining step (S14) to the third restraining step (S15). As a result, the short-circuit paths of the electrode layer 14 and the electrode layer 15 are cut. As a result, the short-circuit state is suppressed, and the short-circuit resistance increases. When the second restraining force is 8 times or more of the first restraining force, the short-circuit path can be cut more effectively.

As described above, the power storage device according to Embodiment 1 includes the first restraining step (S11), the second restraining step (S14), and the third restraining step (S15) described above, whereby a short circuit caused by a conductive foreign substance can be suppressed.

In the above description, the conductive foreign matter is a precipitated foreign matter dissolved on the positive electrode side and precipitated on the negative electrode side, and the precipitated foreign matter is a SUS metal. However, the present disclosure is not limited thereto. As long as it can be cut by the reaction of the difference in the restraining force described above, other foreign matters different from the precipitated foreign matters may be used. In the case where the foreign matter is a precipitated foreign matter, the precipitated foreign matter can be effectively cut by the above-described steps.

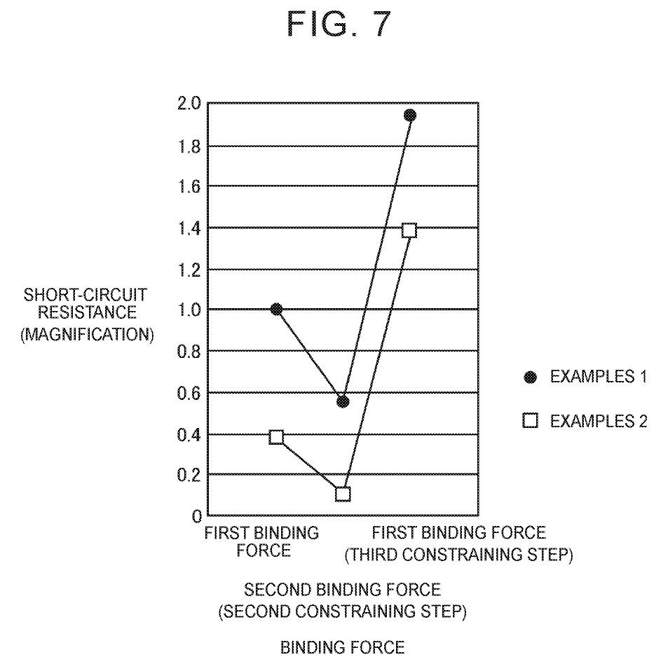

FIG. 7 is a diagram illustrating a change in the short-circuit resistance in a state where the power storage device according to the first embodiment is restrained by the respective restraining forces.

As shown in FIG. 7, a stacked body 1 according to Examples 1 and 2 was prepared. The stacked body 1 according to Examples 1 and 2 is the same as the stacked body 1 according to Embodiment 1, but different states of foreign matters (precipitated foreign matters) contained therein are used. Thus, the short-circuit resistance in the state of being restrained by the first restraining force is different, the short-circuit resistance of the stacked body 1 according to Example 1 was higher than the short-circuit resistance of the stacked body 1 according to Example 2.

In FIG. 7, between the first restraining step (S11) and the second restraining step (S14), on the basis of the short-circuit resistance of Example 1 in the state of being restrained by the first restraining force, the short-circuit resistance in the state of the respective restraining force with respect to the reference, the short-circuit resistance in Example 2 is shown by a ratio. Further, the first constraint force, as a 20 KPa, the second constraint force was 160 KPa.

In the stacked body 1 of each of Examples 1 and 2, it was confirmed that the short-circuit resistance was lower in the state of being restrained by the second restraining force than in the state of being restrained by the first restraining force, and the short-circuit path was formed. Further, in the stacked body 1 of each of Examples 1 and 2, the short-circuit resistance in the state of returning from the second restraining force to the first restraining force in the third restraining step was larger than the short-circuit resistance of Example 1. The short-circuit resistance of the first embodiment is a short-circuit resistance in a state of being restrained by the first restraining force from the first restraining step (S11) to the second restraining step (S14). This confirmed that the short-circuit path was disconnected.

### Second Embodiment

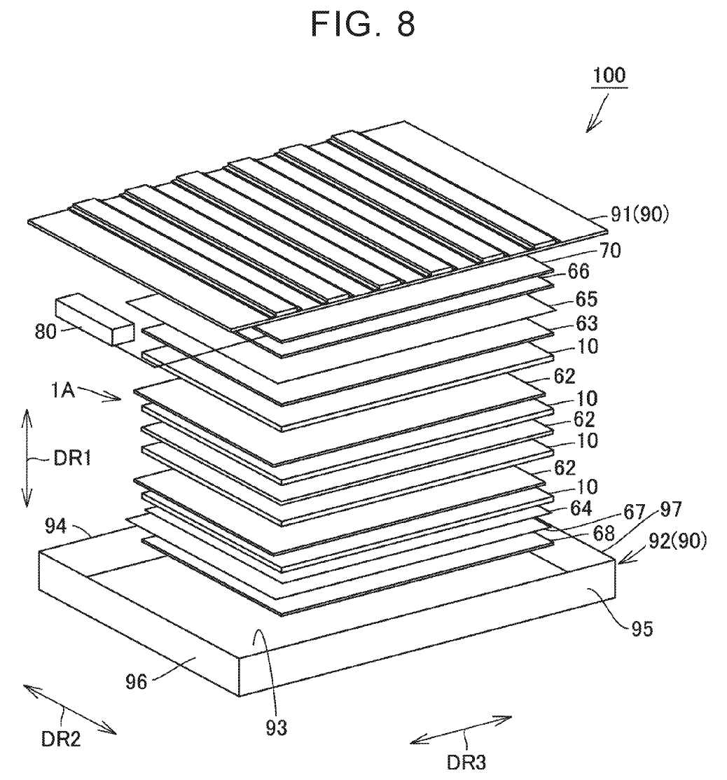

FIG. 8 is a schematic diagram illustrating a power storage device according to a second embodiment. The power storage device 100 according to the second embodiment will be described with reference to FIG. 8.

In the power storage device 100 according to the second embodiment, the change in the restraining force in the first restraining step (S11), the second restraining step (S14), and the third restraining step (S15) in the manufacturing process of the power storage device according to the first embodiment is applied to the power storage device 100. The power storage device 100 according to the second embodiment suppresses a short circuit caused by a precipitated foreign substance by changing the restraining force even when the power storage device 100 is used.

The power storage device 100 includes a housing case 90, a stacked body 1A, an adjustment device 70, and a control device 80.

The stacked body 1A includes a plurality of power storage modules 10, a plurality of coolers 62, a first current collector plate 63 and a second current collector plate 64, insulating sheets 65 and 67, and elastic sheets 66 and 68.

The plurality of power storage modules 10 are arranged in a first direction (DR1 direction). The first direction is, for example, parallel to the vertical direction of the vehicle in a mounted state in which the power storage device 100 is mounted on the vehicle.

The plurality of power storage modules 10 have, for example, substantially the same configuration as that of the first embodiment. Note that the power storage module 10 is not limited to the above, and may be constituted by a rectangular cylindrical secondary battery, an all-solid-state battery, a capacitor, or the like.

The plurality of coolers 62 is disposed between the power storage modules 10 adjacent to each other. The plurality of coolers 62 are provided with a refrigerant flow path through which the refrigerant can flow. The cooler 62 cools the power storage module 10.

The first current collector plate 63 is stacked on one side in the first direction of the power storage module 10 located on the one-most side in the first direction. The first current collector plate 63 is, for example, a current collector plate for a positive electrode. The first current collector plate 63 is connected to a positive electrode terminal (not shown).

The second current collector plate 64 is stacked on the other side in the first direction of the power storage module 10 located on the other side in the first direction. The second current collector plate 64 is, for example, a current collector plate for a negative electrode. The second current collector plate 64 is connected to a negative electrode terminal (not shown). The stacked body 1A is charged and discharged using the negative electrode terminal and the positive electrode terminal described above.

An insulating sheet 65 is disposed on one side of the first current collector plate 63 in the first direction. An elastic sheet 66 is disposed on one side of the insulating sheet 65 in the first direction.

An insulating sheet 67 is disposed on the other side of the second current collector plate 64 in the first direction. An elastic sheet 68 is disposed on the other side of the insulating sheet 67 in the first direction.

The housing case 90 houses the stacked body 1A, the adjustment device 70, and the control device 80 therein. The housing case 90 includes a restraining plate 91 constituting a ceiling portion and a lower case 92.

The restraining plate 91 may be formed of, for example, a metallic member such as a SUS. The restraining plate 91 is fastened and fixed to the side wall portions 96 and 97 of the lower case 92, which will be described later, using a fastening member such as a bolt. The restraining plate 91 may be fastened to the other side wall portions 94 and 95 using a fastening member.

The lower case 92 has a substantially box shape that opens toward one side in the first direction. The lower case 92 may be formed of, for example, a metallic member such as a SUS. The lower case 92 includes a restraining plate 93 as a bottom portion and a plurality of side wall portions 94 to 97.

The restraining plate 93, like the restraining plate 91, has a plate-like shape extending over a wide range. The restraining plate 93 faces the restraining plate 91 in the first direction. By sandwiching the stacked body 1A between the restraining plate 91 and the restraining plate 93, the stacked body 1A is restrained. As described above, the restraining plates 91 and 93 correspond to restraining tools.

The plurality of side wall portions 94 to 97 is provided at the peripheral edge of the restraining plate 93. The plurality of side wall portions 94 to 97 are connected to the peripheral edge of the restraining plate 93. The pair of side wall portions 94 and 95 is opposed to each other in the second direction (DR2 direction). The second direction is a direction orthogonal to the first direction. The second direction is parallel to the left-right direction of the vehicle in the mounted state.

The pair of side wall portions 96 and 97 are opposed to each other in the third direction (DR3 direction). The third direction is parallel to the front-rear direction of the vehicle in the mounted state. The side wall portion 96 connects end portions of the pair of side wall portions 94 and 95 located on one side (front side) in the third direction. The side wall portion 97 connects end portions of the pair of side wall portions 94 and 95 located on the other side (rear side) in the third direction.

The adjustment device 70 adjusts the restraining force of the restraining tool on the stacked body 1A. The adjustment device 70 is, for example, arranged between the restraining plate 91 and the stacked body 1A. Note that the position of the adjustment device 70 is not limited to the above, and the restraining force on the stacked body 1 can be appropriately changed as much as possible. The adjustment device 70 is configured to be expandable and contractible, for example. When the adjustment device 70 expands, it is possible to apply a restraining force to the stacked body 1A in addition to the restraining force of the restraining tool.

The control device 80 controls the operation of the adjustment device 70. Specifically, the control device 80 controls the operation of the adjustment device 70 so as to return to the first restraining force after setting the second restraining force higher than the first restraining force in the normal state as the control for suppressing the short-circuit path of the power storage module 10. By adjusting the restraining force in this way, as in the first embodiment, it is possible to cut the short-circuit path formed by the precipitated foreign matter or the like deposited during use.

In the second embodiment described above, the adjustment device 70 is configured to be expandable and contractible, but the present disclosure is not limited thereto. The adjustment device 70 may be configured to be able to adjust the restraining force of the restraining plates 91 and 93 on the stacked body 1A by adjusting the fastening force for fastening the restraining plates 91 and 93. In this case, the restraining plates 91 and 93 are not limited to the upper wall and the bottom wall of the housing case 90, and may be formed of a member different from the housing case 90.

The embodiments disclosed herein are illustrative and not restrictive in all respects. The scope of the present disclosure is defined by the claims, and includes all modifications within the meaning and range equivalent to the claims.

What is claimed is:

1. A method of manufacturing a power storage device, comprising:
injecting an electrolyte into each of a plurality of power storage modules of a stacked body in which the power storage modules are stacked in a stacking direction;
after the injecting, restraining the stacked body in the stacking direction with a first restraining force as a first restraining step;
charging the power storage modules in a state of being restrained with the first restraining force;
after the charging, restraining the stacked body in the stacking direction with a second restraining force that is greater than the first restraining force as a second restraining step; and
after the second restraining step, restraining the stacked body in the stacking direction with the first restraining force as a third restraining step.

2. The method of manufacturing a power storage device according to claim 1, wherein the second restraining force is equal to or greater than eight times the first restraining force.

3. The method of manufacturing a power storage device according to claim 1, wherein:
each of the power storage modules includes a positive electrode and a negative electrode arranged in the stacking direction, and a separator disposed between the positive electrode and the negative electrode;
a precipitated foreign matter dissolved at the positive electrode and precipitated from the negative electrode is present in any of the power storage modules; and
the precipitated foreign matter is cut in the stacking direction by a difference in restraining force between the second restraining step and the third restraining step.

4. The method of manufacturing a power storage device according to claim 3, wherein the precipitated foreign matter is SUS-based metal.

5. A power storage device comprising:
a stacked body including a plurality of power storage modules;
a restraining tool that restrains the stacked body;
an adjustment device that adjusts a restraining force by the restraining tool; and
a control device that controls operation of the adjustment device, wherein
the control device controls the operation of the adjustment device so as to return the restraining force to a first restraining force for a normal state after being brought to a second restraining force that is greater than the first restraining force, as control for suppressing a short-circuit path of the power storage modules.
